(19) United States
(12) Patent Application Publication
(10) Pub. No.: US 2025/0276395 A1
(43) Pub. Date: Sep. 4, 2025

(54) COMBUSTION TOOL WITH DETACHABLE HEATING UNIT

(71) Applicant: ROBURN COMPANY LTD., New Taipei City (TW)

(72) Inventor: Chin-Lin TSAI, New Taipei City (TW)

(21) Appl. No.: 18/910,710

(22) Filed: Oct. 9, 2024

(30) Foreign Application Priority Data
Feb. 29, 2024 (TW) 113202054

(51) Int. Cl. B23K 3/02

(52) U.S. Cl. CPC B23K 3/022; B23K 3/026

(57) ABSTRACT

A combustion tool with a detachable heating unit includes: a main body having an insertion pipe, an outer circumferential surface of the insertion pipe is axially formed with at least one insertion having a wedge locking tenon disposed therein; and an unlocking mechanism including a push button, the push button has a block sheet abutting against an elastic member, the block sheet compresses the elastic member, and the push button is automatically recovered to an original position through the elastic member; and a heating unit including a fasten ring and a heating pipe, an elastic support arm is axially protruded from the fasten ring, one free end of the elastic support arm is disposed with a locking hook inserted in the at least one insertion slot and moved along a the wedge locking tenon to form a locking or an unlocking status.

### BACKGROUND OF THE INVENTION

### Field of the Invention

The present invention relates to a combustion tool, especially to a combustion tool allowing a heating unit to be selectively installed or detached according to operation needs.

### Description of the Related Art

Fire is a must have element in our lives. Fire can be used for cooking food and providing lights, and the fire can also be used for combustion operations such as forging, soldering and welding. Take a gas combustor, such as a refillable lighter or a portable gas stove, as an example, an object can be ignited or food can be cooked. As such, the gas combustor still plays an important role in our lives which cannot be easily replaced.

With the convenience provided by the gas combustion, there are two types of gas combustion tools available in the commercial market allowing consumers to choose. The first type of the gas combustion tool is provided with fuel, such as a gas storing function, in others words the gas combustion tool is installed with a filling nozzle, after the filling nozzle is connected to a gas discharging valve of a canned gas, high-pressure liquid gas can be filled and stored in a storage tank of the gas combustion tool, so that a heating unit, such as a soldering iron tip, of the gas combustion tool is supplied with a fuel source during a combustion operation.

Another type of the gas combustion tool is not provided with the fuel storing function, the gas combustion tool is installed with an engage device at a lower end thereof for being connected to a canned gas available in the commercial market; after the fuel in the canned gas is gasified, the heating unit, such as a combustion pipe, of the gas combustion tool is supplied with the fuel source during the combustion operation.

As such, the heating unit of the conventional gas combustion tool is fastened at a distal end of a fuel passageway, mixed fuel gas ejected by the heating unit such as a lighter is ignited through an igniter such as a piezoelectric device or an external fire source for performing the combustion operation.

However, there are many different requirements in terms of combusting or soldering operations. A consumer may face different requirements and needs to prepare more than one gas combustion tools such as a blowtorch and a gas soldering iron to satisfy the current requirement. Accordingly, how to modularize a heating unit satisfying different requirements such as combusting, soldering or heat shrinking to make the gas combustion tool be conveniently and rapidly detached or installed with a selected heating unit is a problem to be solved by the skilled people in the art.

### SUMMARY OF THE INVENTION

One primary objective of the present invention is to provide a combustion tool with a detachable heating unit, in which a selected heating unit can be optionally detached or installed at a downstream end of a main body, so that the combustion tool is provided with a function of replacing the heating unit to satisfy different requirements such as combusting, soldering or heat shrinking.

Another objective of the present invention is to provide a combustion tool with a detachable heating unit, in which the heating unit and the combustion tool can be rapidly assembled or detached, so that advantages of effectively reducing the packing volume and easy to be carried around are provided.

For achieving said objectives, the present invention provides a combustion tool with a detachable heating unit, which including a main body, having an insertion pipe extended from one end thereof, wherein an outer circumferential surface of the insertion pipe is axially formed with at least one insertion slot, and an inner side of each of the insertion slots is radially disposed with a wedge locking tenon; and an unlocking mechanism, including a push button sheathed with a slide slot disposed on the main body and arranged adjacent to the insertion slot to make the push button be provided with an axially pushing function, wherein the push button has a block sheet abutting against an elastic member, the block sheet compresses the elastic member during a moving process, and the push button is automatically recovered to an original position through the elastic member; and a heating unit, including a fasten ring sheathing the insertion pipe and a heating pipe protruded from one side of the fasten ring, wherein an elastic support arm is axially protruded from an inner wall of the fasten ring and arranged at a location corresponding to the insertion slot, one free end of the elastic support arm is inwardly disposed with a locking hook capable of being inserted in the at least one insertion slot and moved along a surface of the wedge locking tenon to form a locking or an unlocking status.

According to one embodiment of the present invention, the main body is configured as a pencil-shaped member, another end thereof is disposed with a fuel storage tank communicating with a filling nozzle, so that high-pressure liquid gas is able to be filled and stored in the fuel storage tank via the filling nozzle.

According to one embodiment of the present invention, the outer circumferential surface of the insertion pipe is axially formed with a pair of the insertion slots diagonally arranged.

According to one embodiment of the present invention, a gas guiding pipe is extended in the insertion pipe, and a downstream end of the gas guiding pipe is connected to a gas ejecting nozzle.

According to one embodiment of the present invention, the push button is extended with a pair of slide hooks radially spaced and symmetrically arranged and capable of being buckled at a top edge of an inner wall and a bottom edge of the inner wall of the slide slot.

According to one embodiment of the present invention, an amount of the slide hooks is two pairs spaced with intervals, and the block sheet is clamped between the two pairs of the slide hooks.

According to one embodiment of the present invention, a spring tenon allowing the elastic member to be sheathed is axially protruded from the slide slot, the block sheet is formed with a penetrated slot allowing the spring tenon to penetrate, thus the block sheet is able to move along the penetrated slot to compress the elastic member.

According to one embodiment of the present invention, the heating unit further includes a soldering iron tip connected to the heating pipe.

According to one embodiment of the present invention, the elastic support arms are oppositely disposed on a circumferential surface of an inner ring, a pair of elastic connection arms are oppositely and axially protruded from one side of the pair of elastic support arms of the inner ring, a free end surface of the pair of elastic connection arms is formed with a plurality of latching grooves, and a latching hook latched in the latching grooves is disposed on an inner circumferential surface of the fasten ring and arranged at a location corresponding to the free end surface of each of the elastic connection arms.

According to one embodiment of the present invention, at least one positioning tenon capable of sliding and sheathing and a positioning slot allowing each of the positioning tenons to be sheathed are oppositely disposed on connecting surfaces of the fasten ring and the inner ring respectively.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a perspective exploded view showing the combustion tool and the heating unit according to the present invention;

FIG. 2 is a perspective exploded view showing the combustion tool and the unlocking mechanism according to the present invention;

FIG. 3 is a perspective view showing the unlocking mechanism of FIG. 2 being installed in the combustion tool according to the present invention;

FIG. 4 is a perspective view showing the assembly of the combustion tool and the heating unit according to the present invention;

FIG. 5 is a cross sectional view taken along an A-A dashed line of FIG. 4 to show the push button being buckled with the main body;

FIG. 6 is a cross sectional view taken along a B-B dashed line of FIG. 4 to show the combustion tool and the heating unit being connected and locked;

FIG. 7 is a cross sectional view taken along a C-C dashed line of FIG. 4 to show the fasten ring being buckled with the inner ring;

FIG. 8 is a cross sectional view showing the combustion tool and the heating unit being unlocked and released according to the present invention; and FIG. 9 is an exploded view showing the combustion tool being connected to the another type of heating unit according to the present invention.

### DETAILED DESCRIPTION OF THE PREFERRED EMBODIMENTS

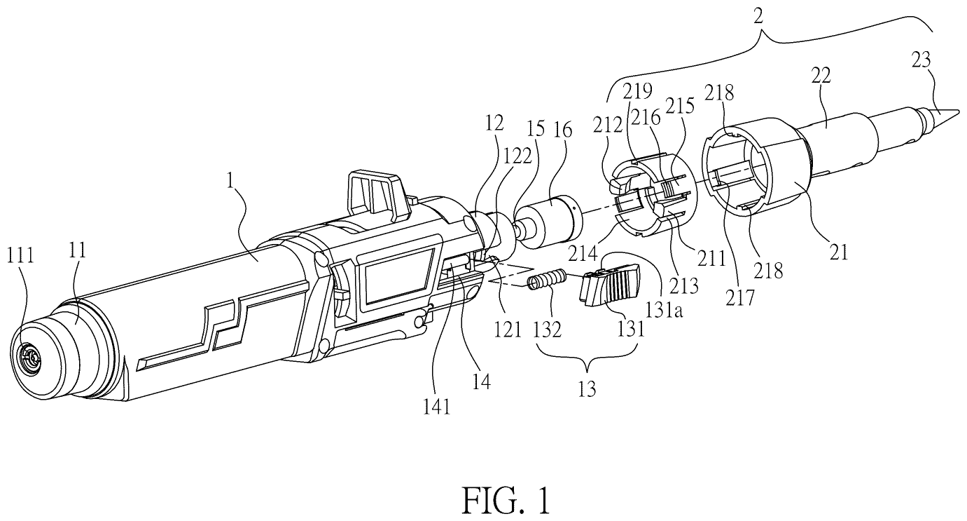

Please refer from FIG. 1 to FIG. 7, the present invention provides a combustion tool, which includes a main body 1 and a heating unit 2.

The main body 1 is configured as a pencil-shaped member, and one end thereof is disposed with a fuel storage tank 11. One free end of the fuel storage tank 11 is in communication with a filling nozzle 111, so that high-pressure liquid gas is able to be filled and stored in the fuel storage tank 11 via the filling nozzle 111 to provide an advantage of being convenient in operation. Another end of the main body 1 is extended with an insertion pipe 12. An outer circumferential surface of the insertion pipe 12 is axially formed with at least one insertion slot 121. According to one embodiment of the present invention, the outer circumferential surface of the insertion pipe 12 is axially formed with a pair of the insertion slots 121 diagonally arranged. Wherein, an inner side of each of the insertion slots 121 is radially disposed with a wedge locking tenon 122 to form a locking status with the heating unit 2. Wherein, a gas guiding pipe 15 used for conveying high-pressure fuel gas is extended in the insertion pipe 12. A downstream end of the gas guiding pipe 15 is connected to a gas ejecting nozzle 16. As such, after the fuel in the fuel storage tank 11 is gasified, the gasified fuel is conveyed through the gas guiding pipe 15 for being ejected from the gas ejecting nozzle 16.

For providing an unlocking function to the heating unit 2, an unlocking mechanism 13 is disposed at one side of the insertion slot 121. The unlocking mechanism 13 includes a push button 131 and an elastic member 132 such as a spring. The push button 131 is sheathed with a slide slot 14 disposed on the main body 1 arranged adjacent to the insertion slot 121 to make the push button 13 be provided with an axially pushing function. The push button 131 is extended with a pair of slide hooks 13 la radially spaced and symmetrically arranged and capable of being buckled at a top edge of an inner wall and a bottom edge of the inner wall of the slide slot 14, and the push button 131 is disposed with a block sheet 131b capable of abutting against one end of the elastic member 132. A spring tenon 141 allowing the elastic member 132 to be sheathed is axially protruded from the slide slot 14. The block sheet 131b is formed with a penetrated slot 131c allowing the spring tenon 141 to penetrate, thus the block sheet 131b is able to move along the penetrated slot 131c to compress the elastic member 132.

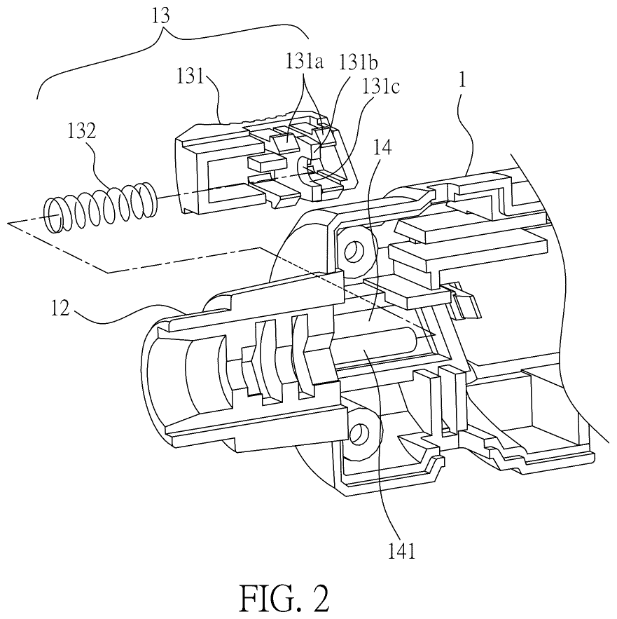

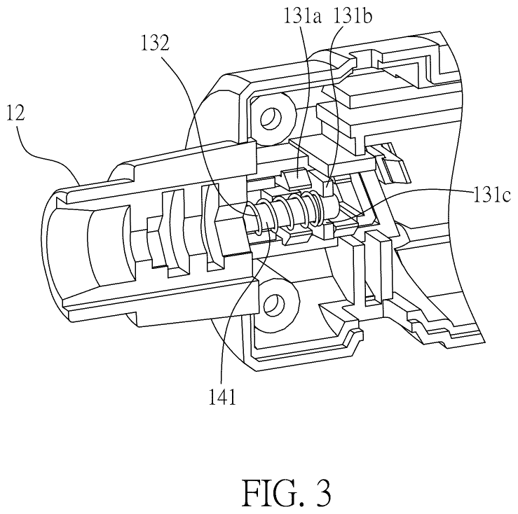

Please refer to FIG. 2 and FIG. 3, the amount of the slide hooks 131a is preferably to be two pairs spaced with intervals, and the block sheet 131b is clamped between the two pairs of the slide hooks 131a.

Please refer to FIG. 1, the heating unit 2 includes a fasten ring 21 sheathing the insertion pipe 12, a heating pipe 22 protruded from one side of the fasten ring 21, and a soldering iron tip 23 connected to the heating pipe 22. An elastic support arm 211 is axially protruded from an inner wall of the fasten ring 21 and arranged at a location corresponding to each of the insertion slots 121. One free end of each of the elastic support arms 211 is inwardly disposed with a locking hook 212 capable of being inserted in the at least one insertion slot 121 and moved along a surface of the wedge locking tenon 122 to form a locking or an unlocking status, thus the insertion pipe 12 is inserted in the fasten ring 21 for a purpose of installation.

For providing a better appearance, slits 213 at two sides of each of the elastic support arms 211 are shielded, thus the elastic support arms 211 are oppositely disposed on a circumferential surface of an inner ring 214. For allowing the inner ring 214 and the fasten ring 41 to be combined as one piece, a pair of elastic connection arms 215 are oppositely and axially protruded from one side of the pair of elastic support arms 211 of the inner ring 214, a free end surface of the pair of elastic connection arms 215 is formed with a plurality of latching grooves 216, and a latching hook 217 is disposed on an inner circumferential surface of the fasten ring 21 and arranged at a location corresponding to the free end surface of each of the elastic connection arms 215. Moreover, at least one positioning tenon 218 capable of sliding and sheathing and a positioning slot 219 allowing each of the positioning tenons 218 to be sheathed are oppositely disposed on connecting surfaces of the fasten ring 21 and the inner ring 214 respectively.

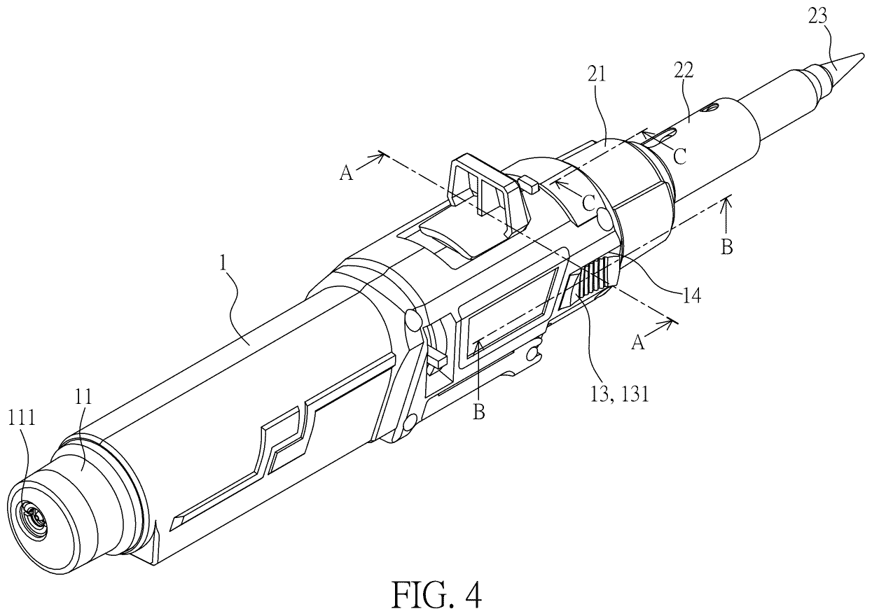

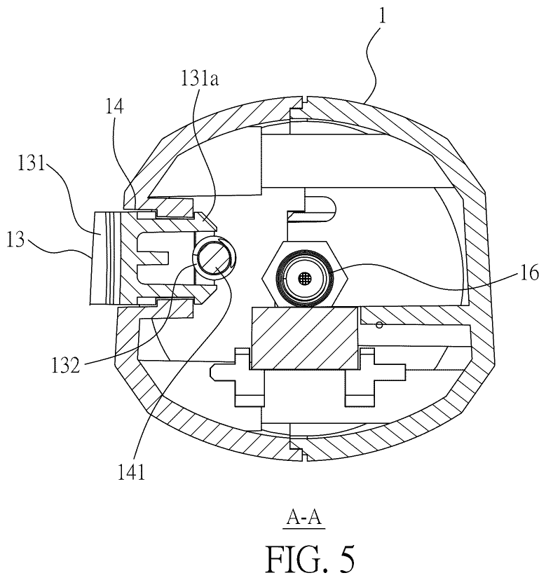

Please refer from FIG. 4 to FIG. 7, according to the aforesaid illustrations and drawings, the unlocking mechanism 13 has already been installed in the slide slot 14 of the main body 1, and each pair of the slide hooks 131a of the push button 131 has been buckled at the top edge and the bottom edge of the inner wall of the slide slot 14 (as shown in FIG. 5), and the elastic member 132 is constantly in a stretched status.

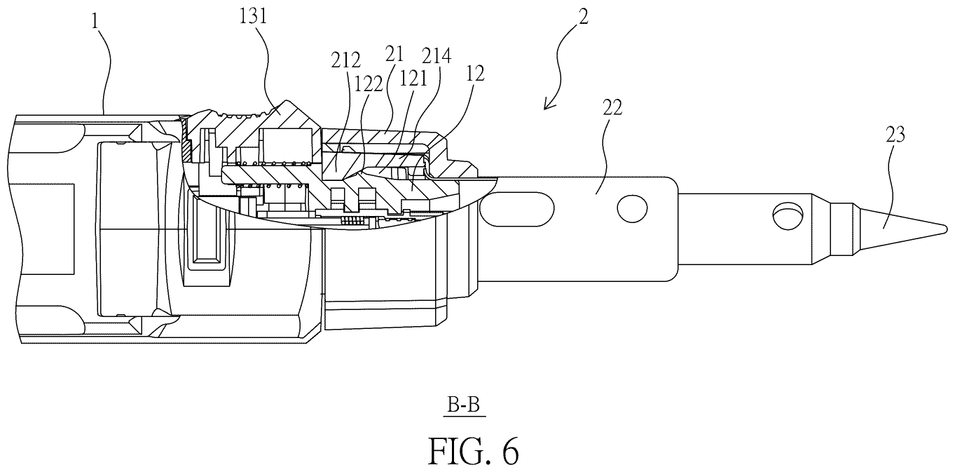

Moreover, the locking hook 212 of each of the elastic support arms 211 of the fasten ring 21 is buckled with the wedge locking tenon 122 of the corresponding insertion slot 121 to form a locking status (as shown in FIG. 6), in other words the heating unit 2 is inserted in the insertion pipe 12 via the fasten ring 21 to be disposed at one end of the main body 1.

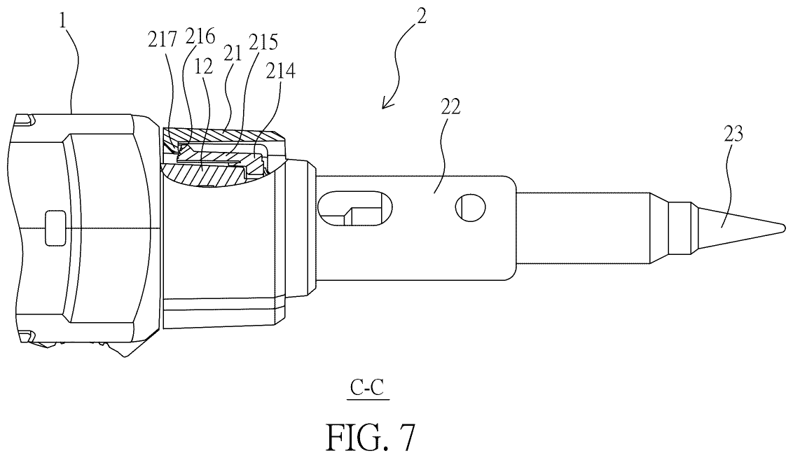

Moreover, the combination of the fasten ring 21 and the inner ring 214 utilizes a manner of the positioning slots 219 of the inner ring 214 respectively being aimed at one of the corresponding positioning tenons 218 of the fasten ring 21 and being inserted and slid until the latching hooks 217 of the fasten ring 21 being buckled with one of the corresponding latching grooves 216 of the elastic connection arms 215, thus the inner ring 214 is fastened with the fasten ring 21 to be combined as one piece (as shown in FIG. 7).

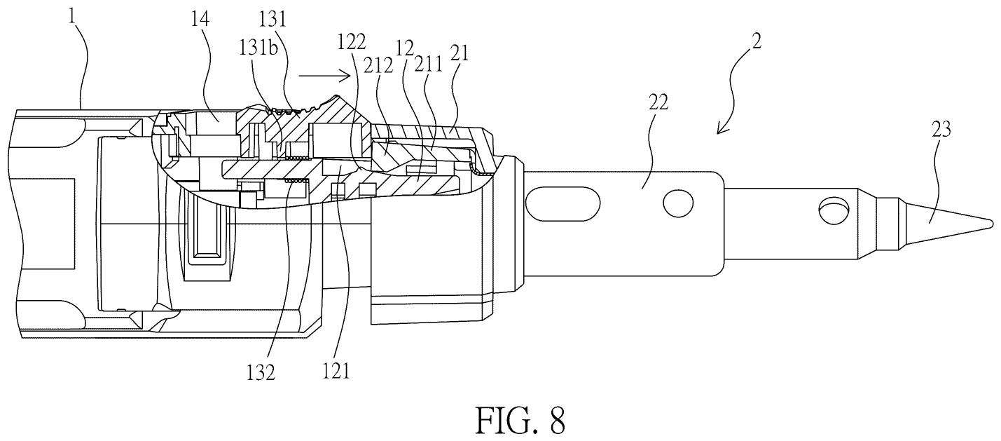

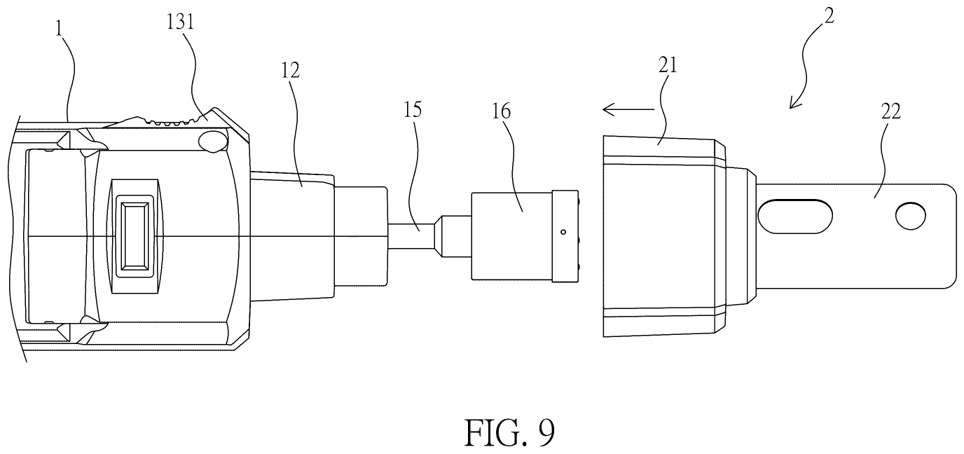

Please refer to FIG. 8 and FIG. 9, the main body 1 of the combustion tool is combined with the heating unit 2 having a soldering function to form as a gas soldering iron. When a soldering operation is required to be operated by a user and another type of the heating unit 2 is desired to be replaced for performing another type of operation (as shown in FIG. 9), for example a gas ejecting torch tool functioning like a blowtorch. At this moment, the user only needs to press the push button 131 to make the push button 131 forwardly move, the block sheet 131b compresses the elastic member 132 during the forward moving process of the push button 131, and the fasten ring 21 is pushed to simultaneously and forwardly move, thus each of the locking hooks 212 is moved along the corresponding wedge locking tenon 122 to be released, thus an unlocking action is achieved, and the push button 131 is automatically recovered to an original position in the slide slot 14 through the elastic member 132, so that the heating unit 2, such as the soldering iron tip, is detached.

Subsequentially, the aforesaid assembling method is utilized to make each of the locking hooks 212 of the elastic support arms 211 of the another type of heating unit 2 be inserted in the corresponding insertion slots 121 until each of the locking hooks 212 being backwardly moved along the corresponding wedge locking tenon 122 and crossing over the wedge locking tenon 122, thus a buckled locking status is formed, in other words the assembly of the another type of heating unit 2 and the main body 1 is finished.

Based on what has been disclosed above, advantages achieved by the present invention are as follows. The heating unit is designed to be modularized. The heating unit having different heating functions can be replaced according to actual operation needs, thus different combustion operation requirements are satisfied. Moreover, the heating unit and the main body can be rapidly assembled or detached, thus advantages of effectively reducing the packing volume and easy to be carried around are provided. Accordingly, the present invention is novel and more practical in use comparing to prior arts.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A combustion tool with a detachable heating unit, including:
a main body, having an insertion pipe extended from one end thereof, wherein an outer circumferential surface of said insertion pipe is axially formed with at least one insertion slot, and an inner side of each of said at least one insertion slot is radially disposed with a wedge locking tenon; and an unlocking mechanism, including a push button sheathed with a slide slot disposed on said main body and arranged adjacent to one said insertion slot to make said push button be provided with an axially pushing function, wherein said push button has a block sheet abutting against an elastic member, said block sheet compresses said elastic member during a moving process, and said push button is automatically recovered to an original position through said elastic member; and
a heating unit, including a fasten ring sheathing said insertion pipe and a heating pipe protruded from one side of said fasten ring, wherein an elastic support arm is axially protruded from an inner wall of said fasten ring and arranged at a location corresponding to one said insertion slot, one free end of said elastic support arm is inwardly disposed with a locking hook capable of being inserted in said at least one insertion slot and moved along a surface of said wedge locking tenon to form a locking or an unlocking status.

2. The combustion tool with the detachable heating unit as claimed in claim 1, wherein said main body is configured as a pencil-shaped member, another end of said main body is disposed with a fuel storage tank communicating with a filling nozzle, so that high-pressure liquid gas is able to be filled and stored in said fuel storage tank via said filling nozzle.

3. The combustion tool with the detachable heating unit as claimed in claim 1, wherein said outer circumferential surface of said insertion pipe is axially formed with two said insertion slots diagonally arranged.

4. The combustion tool with the detachable heating unit as claimed in claim 1, wherein a gas guiding pipe is extended in said insertion pipe, and a downstream end of said gas guiding pipe is connected to a gas ejecting nozzle.

5. The combustion tool with the detachable heating unit as claimed in claim 1, wherein said push button is extended with a pair of slide hooks radially spaced and symmetrically arranged and capable of being buckled at a top edge of an inner wall and a bottom edge of said inner wall of said slide slot.

6. The combustion tool with the detachable heating unit as claimed in claim 5, wherein an amount of said slide hooks is two pairs spaced with intervals, and said block sheet is clamped between said two pairs of said slide hooks.

7. The combustion tool with the detachable heating unit as claimed in claim 1, wherein a spring tenon allowing said elastic member to be sheathed is axially protruded from said slide slot, said block sheet is formed with a penetrated slot allowing said spring tenon to penetrate, thus said block sheet is able to move along said penetrated slot to compress said elastic member.

8. The combustion tool with the detachable heating unit as claimed in claim 1, wherein said heating unit further includes a soldering iron tip connected to said heating pipe.

9. The combustion tool with the detachable heating unit as claimed in claim 1, wherein two said elastic support arms are oppositely disposed on a circumferential surface of an inner ring, two elastic connection arms are oppositely and axially protruded from one side of the two said elastic support arms of said inner ring, a free end surface of said pair of elastic connection arms is formed with a plurality of latching grooves, and a latching hook latched in said latching grooves is disposed on an inner circumferential surface of said fasten ring and arranged at a location corresponding to said free end surface of each said elastic connection arm.

10. The combustion tool with the detachable heating unit as claimed in claim 9, wherein at least one positioning tenon capable of sliding and sheathing and a positioning slot allowing each said positioning tenon to be sheathed are oppositely disposed on connecting surfaces of said fasten ring and said inner ring respectively.
